(19) United States
(12) Patent Application Publication
(10) Pub. No.: US 2022/0397167 A1
(43) Pub. Date: Dec. 15, 2022

(54) BRAKE HOUSING

(71) Applicant: ADVANCED BRAKING PTY LTD, Wangara (AU)

(72) Inventors: Guy HAINSWORTH, Scarborough (AU); Anthony VAN LITSENBORGH, Spearwood (AU)

(73) Assignee: ADVANCED BRAKING PTY LTD, Wangara (AU)

(21) Appl. No.: 17/775,525

(22) PCT Filed: Nov. 9, 2020
(86) PCT No.: PCT/AU2020/051222

§ 371 Date: May 9, 2022

(30) Foreign Application Priority Data
Nov. 8, 2019 (AU) 2019904210

(51) Int. Cl. F16D 65/00

(52) U.S. Cl. CPC F16D 65/0031; F16D 65/0081; F16D 2055/0033

(57) ABSTRACT

A housing for a brake system for attachment to an axle of a vehicle, the brake system comprising a braking mechanism having a rotor attached to a hub, and a caliper for receiving a portion of the outer circumference of the rotor permitting stopping rotation of the rotor, the housing comprising a body defining the space for containment of the braking mechanism, and a circular portion having an outer periphery configured to divert debris generated during operation of the vehicle from the outer periphery, wherein the outer periphery comprises a plurality of channels arranged in a spaced apart relationship with respect to each other, the channels extending transversally from one side of the housing to the other side of the housing to divert the debris away from the outer periphery.

### TECHNICAL FIELD

The present invention relates to brake systems, such as vehicle brake systems.

The invention has been devised particularly, although not necessarily solely, in relation to housings for brake systems of vehicles.

### BACKGROUND ART

The following discussion of the background art is intended to facilitate an understanding of the present invention only. The discussion is not an acknowledgement or admission that any of the material referred to is or was part of the common general knowledge as at the priority date of the application.

Braking systems comprising housings for containments of braking mechanism are known. The housing of the conventional braking systems comprise bodies having shapes that encourage buildup of debris on their outer surfaces. The buildup of debris on the housing reduces the ability to transfer heat from the interior of the housing and the exterior of the housing. The debris build-up makes maintenance work on the housing more cumbersome.

Further, conventional housings enclosing braking mechanism of vehicles are not configured to fit properly within the confined spacing of the areas defined by the rims of the wheels that will at least partially surround the brake housings.

Moreover, it is known that a significant share in the dust emission from road transport is generated by the brake systems of automotive vehicles. In particular, it is estimated that each vehicle generates annually about 0.5 kg of dust pollution solely due to braking. This particular dust pollution comprises mainly friction material of the pads incorporated in the vehicle brakes. The friction material of brake pads comprises toxic organic compounds and heavy metals which each time a driver brakes are liberated into the environment in the form of particular matter a particle diameter smaller than 2 μm. Particulate matter of that relatively small size (about 2 μm) is harmful to humans and other living beings. In view of the health hazard, due to the dust emission generated during braking, it has been recommended by authorities that systems be developed that would reduce the emission of particulate matter from vehicle braking mechanisms.

It is against this background that the present invention has been developed.

### SUMMARY OF INVENTION

According to a broad aspect of the invention there is provided a housing for a brake system for attachment to an axle of a vehicle, the brake system comprising a braking mechanism having a rotor attached to a hub and a caliper for receiving a portion of the outer circumference of the rotor permitting stopping rotation of the rotor, the housing comprising a body defining the space for containment of the braking mechanism, and a circular portion having an outer periphery configured to divert debris generated during operation the vehicle from the outer periphery.

Preferably, the outer periphery comprises a plurality of channels arranged in a spaced apart relationship with respect to each other, the channels being configured to divert the debris away from the outer periphery.

According to a first aspect of the invention there is provided a housing for a brake system for attachment to an axle of a vehicle, the brake system comprising a braking mechanism having a rotor rotatably attached to a hub, and a caliper for receiving a portion of the outer circumference of the rotor permitting stopping rotation of the rotor, the housing comprising a body defining the space for containment of the braking mechanism, and a circular portion having an outer periphery configured to divert debris generated during operation the vehicle from the outer periphery, wherein the outer periphery comprises a plurality of channels arranged in a spaced apart relationship with respect to each other, the channels extending transversally from one side of the housing to the other side of the housing to divert the debris away from the outer periphery.

Preferably, the housing comprises a plurality of protrusions arranged in a spaced apart relationship with respect to each other surrounding the periphery.

Preferably, between each adjacent protrusions are formed an interspace.

Preferably, the interspace defines a surface that is at a lower location with respect to the highest point of the protrusions protruding from the outer periphery.

Preferably, the interspaces comprise inclined faces.

Preferably each interspace defines one of the channels permitting diverting debris that may fall onto the outer periphery.

Preferably, the outer periphery comprises first and second wall segments each of the first wall segments being arranged side by side, and each of the second wall segments being arranged side by side.

Preferably, the first wall segments are arranged side by side at particular orientations with respect to each other such that each first wall segment define an angle different than zero with respect to the adjacent first wall segment.

Preferably, the angle is equal to the angle of repose of the material on which the vehicle is operating.

Preferably, the second wall segments are arranged side by side at particular orientations with respect to each other such that each second wall segment define an angle different than zero with respect to the adjacent second wall segment.

Preferably, the second wall segment of the first wall segments is oriented with respect to the first wall segment of the first wall segments in such a manner that the outer surface of the second wall segment of the first wall segments is oriented a particular angle γ with respect to the outer surface of the first wall segment of the first wall segments.

Preferably, the third wall segment of the first wall segments is oriented with respect to the second wall segment of the first wall segments in such a manner that the outer surface of the third wall segment of the first wall segments is oriented a particular angle β with respect to the outer surface of the first wall segment of the first wall segments.

Preferably, the second wall segment of the second wall segments is oriented with respect to the first wall segment of the second wall segments in such a manner that the outer surface of the second wall segment of the second wall segments is oriented a particular angle α with respect to the outer surface of the first wall segment of the second wall segments.

Preferably, the third wall segment of the second wall segments is oriented with respect to the second wall segment of the second wall segments in such a manner that the outer surface of the third wall segment of the second wall segments is oriented a particular angle β with respect to the outer surface of the first wall segment of the second wall segments.

Preferably, the third wall segment of the first wall segments are configured in such a manner that their inner surface (the surface facing towards the space of the housing) are oriented a particular angle δ with respect to the first wall segment of the first wall segments.

Preferably, the third wall segment of the second wall segments are configured in such a manner that their inner surface (the surface facing the spacing of the housing) are oriented a particular angle δ with respect to the first wall segment of the second wall segments.

Preferably, for a first arrangement, the values of the angles referred to above may the take any of the following values:

a. α=24° to 36°,

b. g=32° to 46°,

c. β=70°, and

d. δ=82°.

Preferably, for a second arrangement, the values of the angles referred to above may the take any of the following values:

a. α=15° to 48°,

b. g=15° to 48°,

c. β=65° to 88°, and

d. δ=65° to 88°

In a particular arrangement, the third wall segment of the first wall segments is oriented with respect to the second wall segment of the first wall segments in such a manner that the outer surface of the third wall segment of the first wall segments is oriented a particular angle β with respect to the outer surface of the first wall segment of the first wall segments, wherein the angle β is equal to 90°.

In a particular arrangement, the third wall segment of the second wall segments is oriented with respect to the first wall segment of the second wall segments in such a manner that the outer surface of the third wall segment of the second wall segments is oriented a particular angle β with respect to the outer surface of the first wall segment of the second wall segments, wherein the angle β is equal to 90°.

Preferably, the housing comprises an outer shell facing away from the vehicle, and an inner shell facing towards the vehicle.

Preferably, the inner shells are adapted to be releasably attached to each other for defining the space that contains the braking mechanism.

Preferably, the inner and outer shell comprises sub-protrusions protruding from the outer periphery of each outer and inner shells and defining the protrusions when the inner and outer shells are joined together.

Preferably, a sealing assembly is located between the inner and outer shells.

Preferably, the sealing assembly comprises an O-ring gasket.

Preferably, the outer shell comprise outer peripheral section defined by the first wall segments arranged side by side.

Preferably, the inner shell comprise outer peripheral section defined by the second wall segments arranged side by side.

According to a second aspect of the invention there is provided a brake system for attachment to an axle of a vehicle, the brake system comprising a braking mechanism having a rotor attached to a hub, and a caliper for receiving a portion of the outer circumference of the rotor permitting stopping rotation of the rotor, and a housing as defined in the first aspect of the invention for containment of the braking mechanism.

According to a third aspect of the invention there is provided a housing for a brake system for attachment to an axle of a vehicle, the brake system comprising a braking mechanism having a rotor rotatably attached to a hub, and a caliper for receiving a portion of the outer circumference of the rotor permitting stopping rotation of the rotor, the housing comprising inner and outer shells when joined together define a space for containment of the braking mechanism, the body being adapted to isolate the space from the exterior of the housing, wherein the housing comprises sealing means comprising a rotary-sealing assembly located between outer shell and the hub, the rotary-sealing assembly comprising a shaft seal and V-seals

Preferably, the inner shell comprises an opening, a seal groove surrounding the inner periphery of the opening and comprising the shaft seal.

Preferably, the inner shell further comprises a cover for mounting on the outer surface of the inner shell, the cover having an opening defining inner periphery surrounding a portion of the hub and an outer periphery comprising a plurality of concentric seal grooves facing the outer surface of the inner shell, each concentric seal grooves comprising a V-seal.

Preferably, the concentric seal grooves comprising the V-seals and the seal groove comprising the shaft seal are located side by side when the cover is mounted onto housing.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a side view of a particular arrangement of a brake system accordance with an embodiment of the invention;

FIG. 2 is a top perspective view of the brake system shown in FIG. 1;

FIG. 3 is a top view of a particular arrangement of a brake housing of the brake system shown in FIG. 1;

FIG. 4 is a perspective view of the brake housing shown in FIG. 3;

FIG. 5 is a top view of the brake housing shown in FIG. 4;

FIG. 6 is a cross-sectional view of the brake system shown in FIG. 1;

FIGS. 7 and 8 are details of the cross-sectional view of the brake system shown in FIG. 6;

FIG. 9 shows the brake system shown in FIG. 1 attached the axle on which a wheel is mounted;

FIG. 10 is a cross-sectional view of the brake system shown in FIG. 1;

FIG. 11 is a side view of a particular arrangement of a brake system in accordance with an embodiment of the invention;

FIG. 12 is a top perspective view of the brake system shown in FIG. 11;

FIG. 13 is a top view of a particular arrangement of a brake housing of the brake system shown in FIG. 11;

FIG. 14 is a perspective view of the brake housing shown in FIG. 13;

FIG. 15 is a top view of the brake housing shown in FIG. 14;

FIG. 16 is a cross-sectional view of the brake system shown in FIG. 11;

FIGS. 17 and 18 are details of the cross-sectional view of the brake system shown in FIG. 16;

FIG. 19 shows the brake system shown in FIG. 11 attached to the axle on which a wheel is mounted; and

FIG. 20 is a cross-sectional view of the brake system shown in FIG. 1.

It should be noted that the figures are schematic only and the location and disposition of the components can vary according to the particular arrangements of the embodiments of the present invention as well as of the particular applications of the present invention.

### DESCRIPTION OF EMBODIMENT(S)

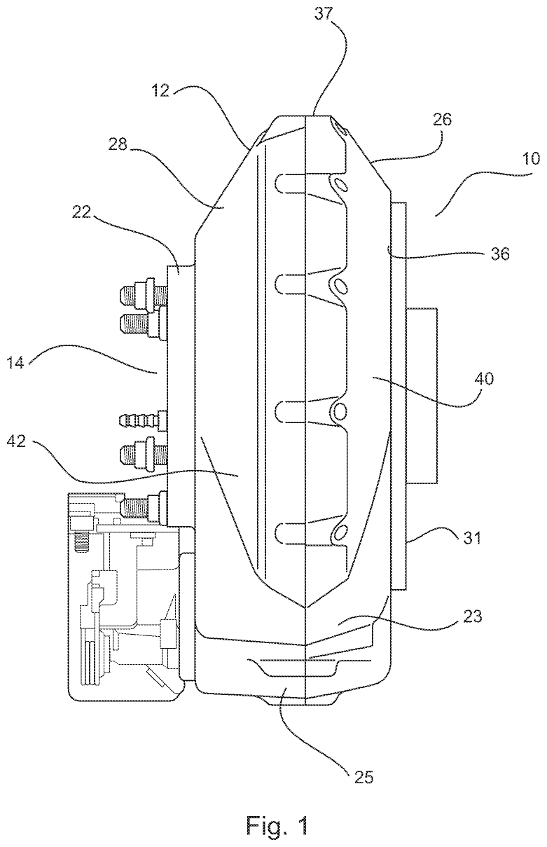

FIGS. 1 2 to 10 and 11 to 20 show, respectively, a first and a second arrangement of a brake system 10 in accordance with the present embodiment of the invention for mounting on one end of a vehicle axle.

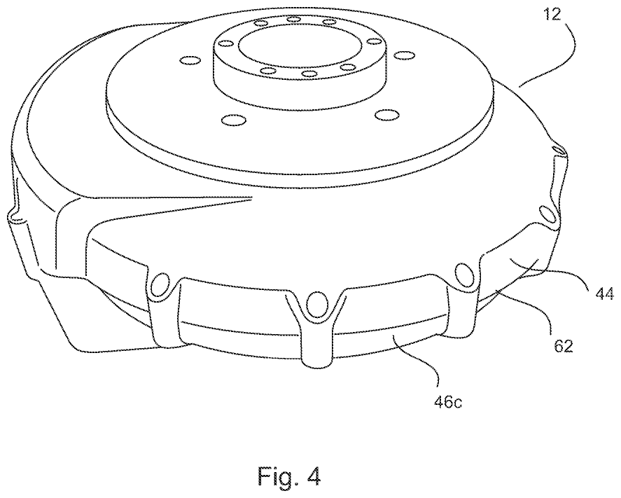

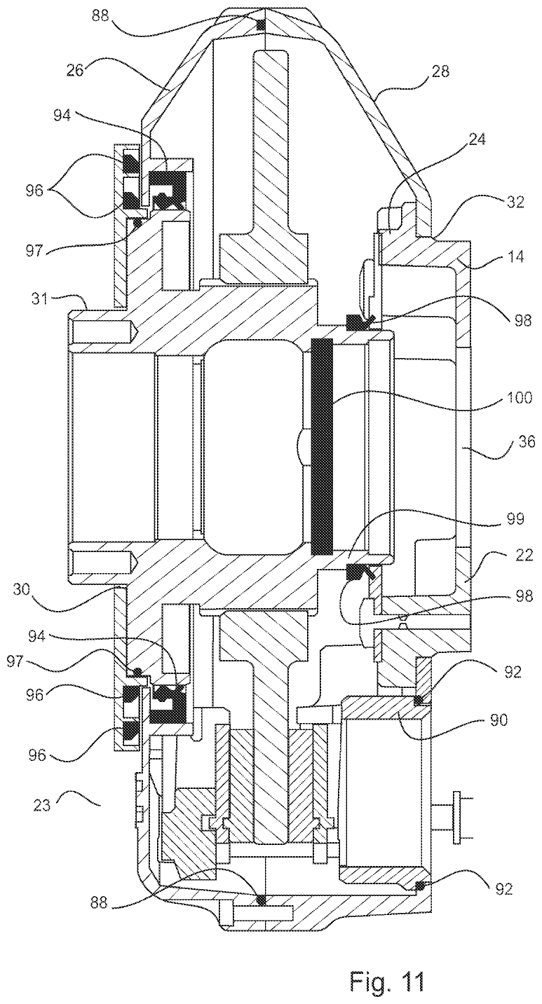

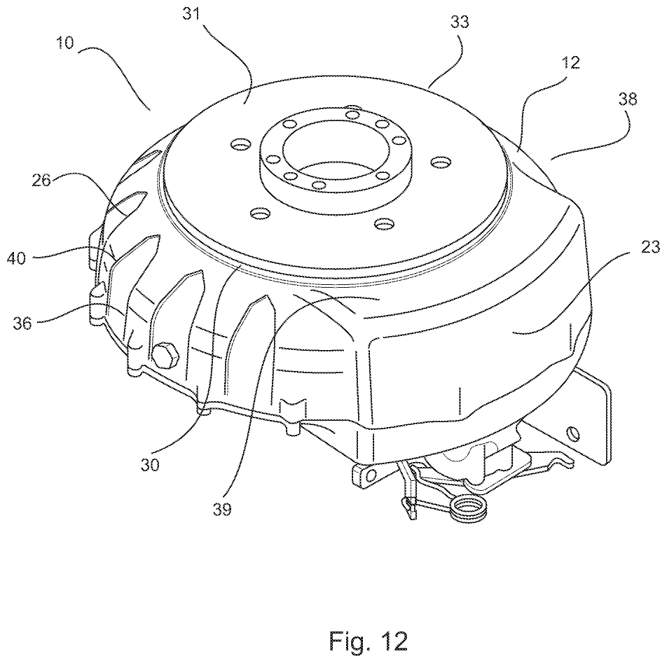

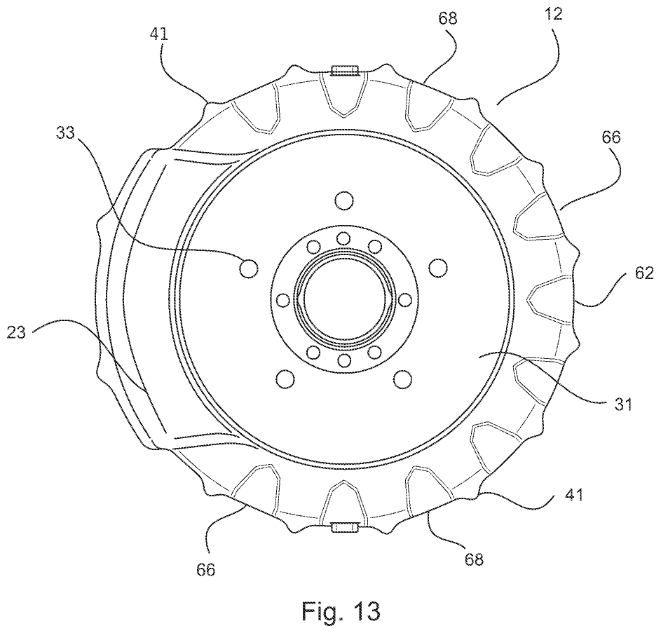

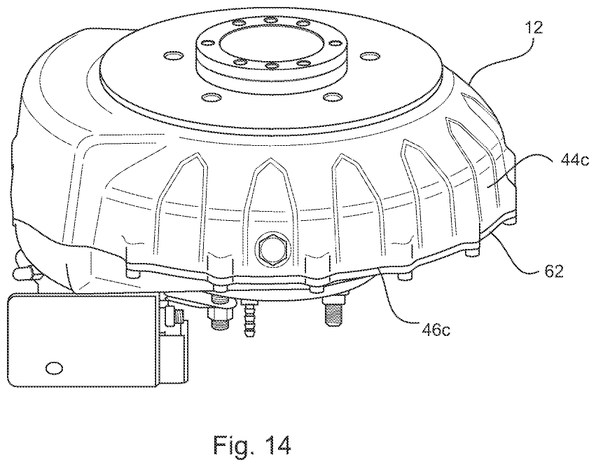

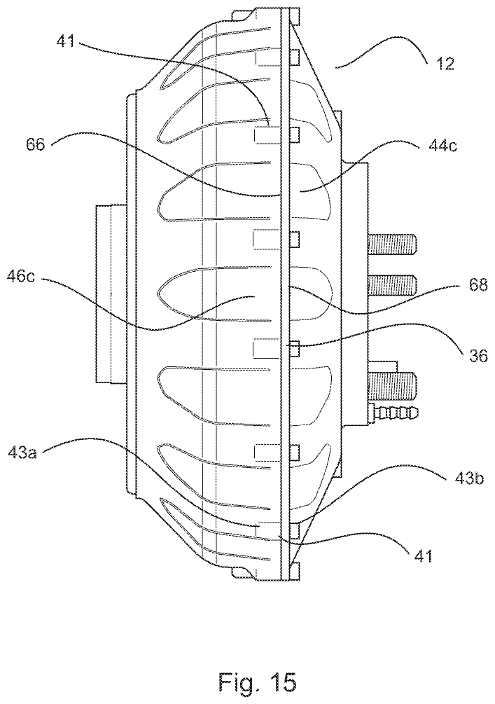

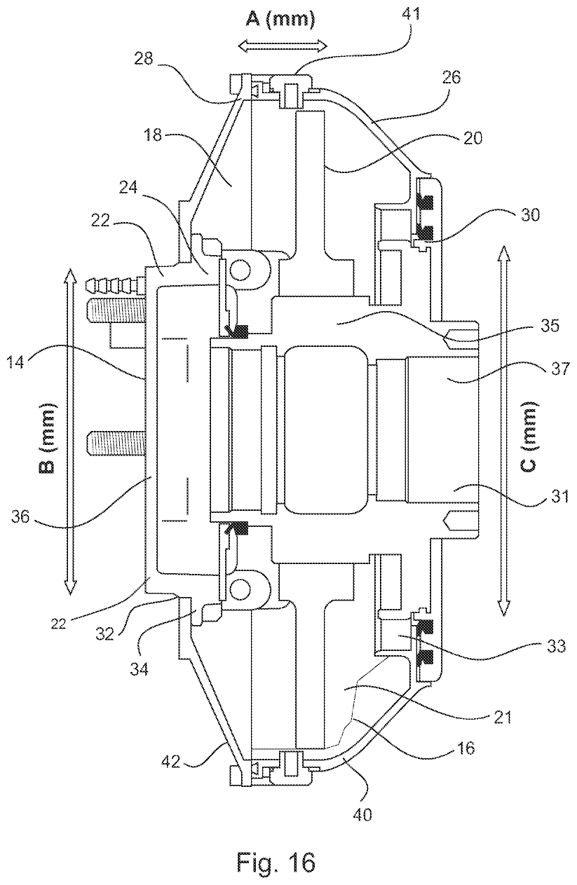

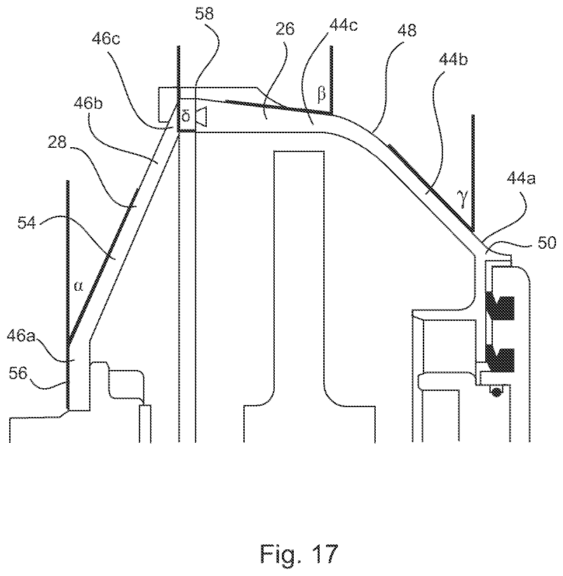

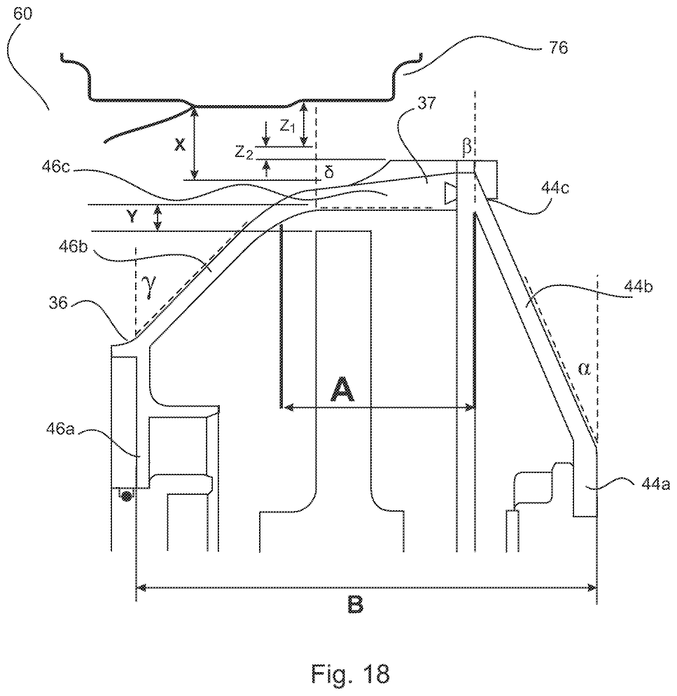

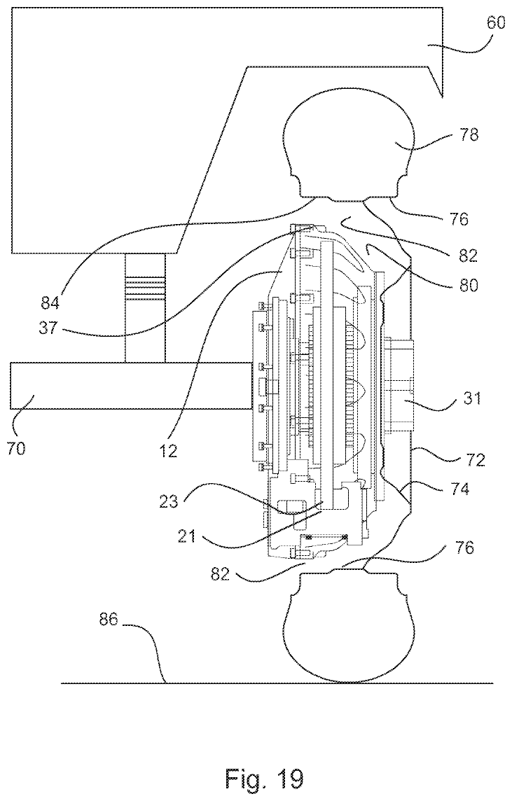

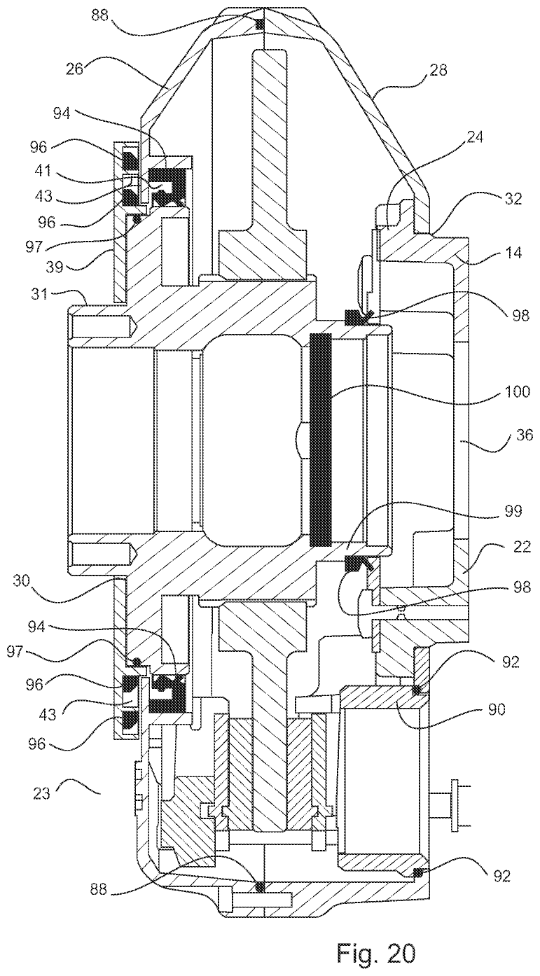

The following description makes reference to the housing 12 depicted in FIGS. 1 to 10; however, the description below also applies to the housing 12 depicted in FIGS. 11 to 20.

The brake system 10 comprises a brake housing 12 and a bracket 14. The bracket 14 is adapted for attachment of the brake system 10 to the end of the axle of the vehicle. In this manner, the brake system 10 is secured to the axle.

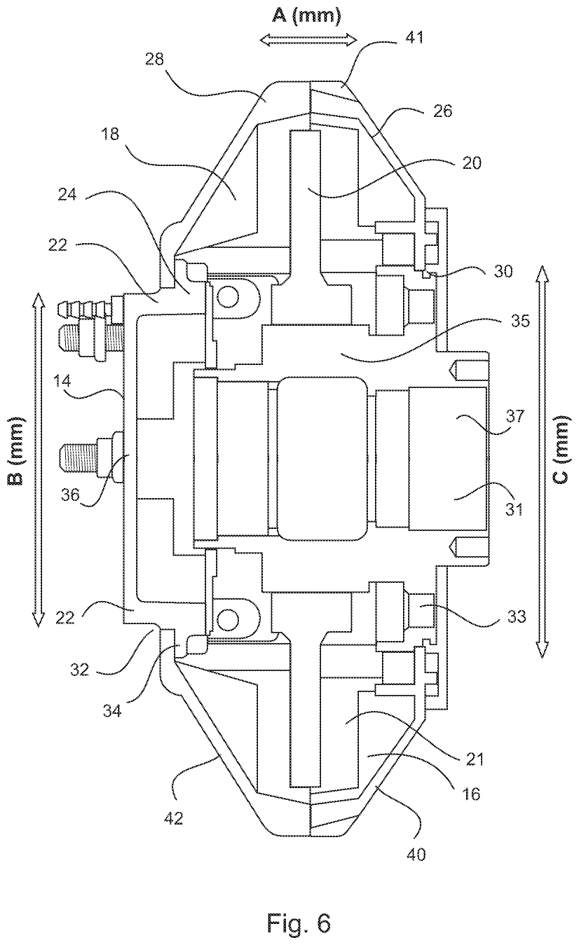

The housing 12 defines a space 16 (see FIG. 6) for containment of the braking mechanism 18 including the rotor 20 and the caliper for receiving a portion of the outer circumference of the rotor 20 permitting stopping rotation of the rotor 20 upon activation of the caliper by the driver of the vehicle.

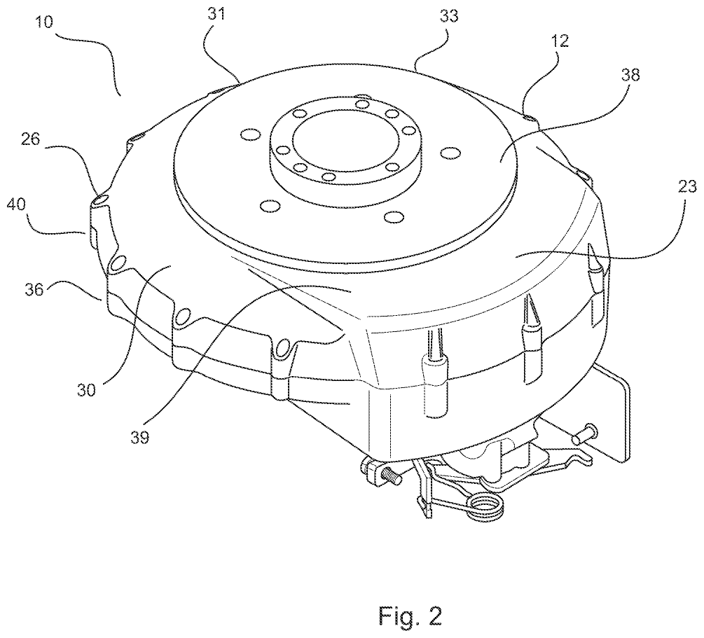

FIGS. 1 and 2 show the braking system 10 in assembled condition prior attachment to the axle of the vehicle. As shown in FIG. 1, the bracket 14 comprises an outer portion 22 extending outward from the housing 12 and an inner portion 24 located within the housing 12 (see FIG. 6). The outer portion 22 is adapted for securing the brake system 10 to the axle of the vehicle and comprises means for providing braking fluid to the caliper.

The housing 12 comprises an outer shell 26 facing away from the vehicle, and an inner shell 28 facing towards the vehicle. The inner shells 26 and 28 are adapted to be releasably attached to each other for defining the space 16 that contains the braking mechanism 18.

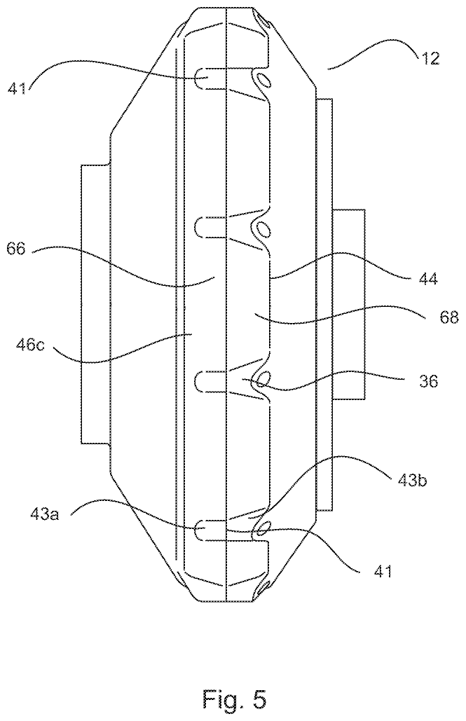

In the first arrangement shown in FIGS. 1 to 10, the inner and outer shell 26 and 28 comprises sub-protrusions 43a and 43b (see FIG. 5) protruding from the outer periphery of each outer and inner shells 26 and 28 and defining protrusions 41 when the inner and outer shells are joined together. Each sub-protrusion 43 comprises holes that, when the outer and inner shells 26 and 28 are joined together, define a hole traversing the protrusion 41 permitting fastening together inner and outer shells 26 and 28 via, for example, nut and bolts.

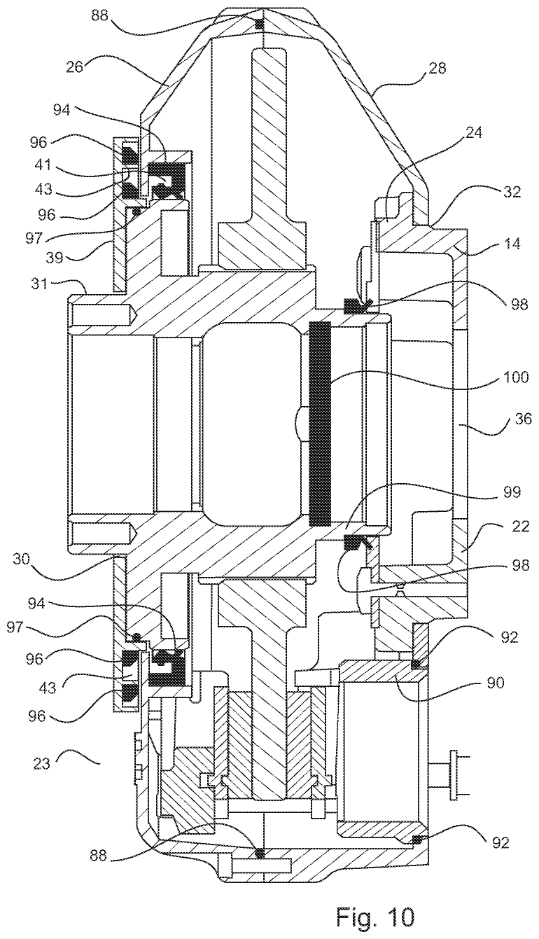

A sealing means are located between the inner and outer shells 26 and 28. In a particular arrangement, as shown in FIG. 10, the sealing means comprises O-ring 88.

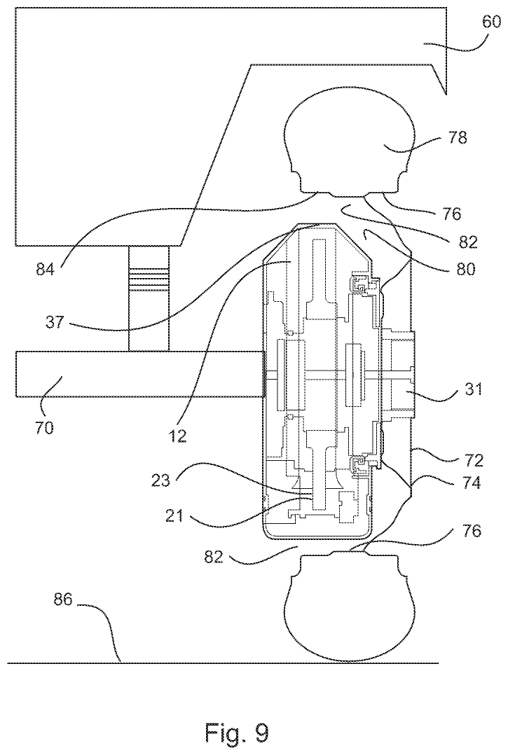

As will be described at a later stage, the inner shells 26 and 28 are configured such that when the housing 12 is assembled, a circular portion 36 and chamber 23 is defined forming a space for receiving the caliper 21 (see FIGS. 9 and 10). The chamber 23 protrudes radially outwards from an arc section of the circular portion 36.

As shown in FIG. 10, the chamber 23 comprises a particular access for receiving the piston housing 90 comprising the piston for operation of the brake pads. Seal means (such as O-ring 92) are provided for sealing the particular access when the piston housing 90 is located within the chamber 23.

As shown in FIG. 6, the outer shell 26 has a first opening 30 and the inner shell 28 has a second opening 32; both openings 30 and 32 are axially aligned with respect to each other.

The first opening 30 is adapted to receive a hub 31 for mounting of the wheel of the vehicle. In a particular arrangement, the hub 31 is received through the first opening 30 after removal of the cover 39 outer shell 16.

As shown in FIG. 6, the hub 31 comprises an inner portion 35 and an outer portion 37. The inner portion 35 reaches into the housing 12 and is adapted to be mounted on the axle; the outer portion 37 faces away from the vehicle and extends outward the inner shell 26.

Further, the hub 31 comprises indentations 33 for receiving studs (not shown) for securing the wheel to the hub 31. The hub 31 is mounted on the axle housing (to be referred to later) permitting rotation of the hub 31 around the axle. In rear wheel drive vehicles, the housing 12, bracket 14 and axle housing are stationary while the hub 31 is able to rotate on bearing assemblies mounted on the axle housing. However, the housing 12 in accordance with the present embodiment of the invention may be used in connection with axles that are driven by the engine of the vehicles such as the rear axles of rear wheel drive vehicles or all axles of four wheel drive vehicles. The housing 12 can also be used in conjunction with trailers and semi-trailers.

The housing 12 comprises inner 28 and outer 26 shells define a space for containment of the braking mechanism, the body being adapted to isolate the space from the exterior of the housing 12, wherein the housing 12 comprises sealing means comprising a rotary-sealing assembly located between outer shell 26 and the hub 31.

The outer shell 26 comprises an opening 30, a seal groove 41 surrounding the inner periphery of the opening 30 and comprising the shaft seal 94.

The inner shell 26 further comprises a cover 39 for mounting on the outer surface of the outer shell 26, the cover 39 having an opening defining inner periphery surrounding a portion of the hub 31 and an outer periphery comprising a plurality of concentric seal grooves 43 facing the outer surface of the inner shell, each concentric seal groove 43 comprising a V-seal 96. The cover 39 is configured such that the concentric seal grooves 43 comprising the V-seals 96 and the seal groove 41 comprising the shaft seal 94 are located side by side when the cover 39 is mounted onto housing 12.

The rotary sealing assembly which forms a rotary seal between the outer shell 26 (in particular, its opening 30) and a hub 31 mounted on the axle housing. In a particular arrangement, the rotary sealing assembly comprises (as shown in FIG. 10) a shaft seal 94, V-seals 96 and O-rings 97.

Referring now to the inner shell 28, the second opening 32 permits receiving the bracket 14 such that its inner portion 24 is located within the housing 12 and its outer portion 22 is located outside the housing as shown in FIG. 6. A sealing assembly such as O-ring seals may be sandwiched between the inner rim of the second opening 32 and the inner portion 24.

The housing 12 includes another rotary sealing assembly which forms a rotary seal between the opening of the inner portion 24 of the bracket 14 (see FIG. 10) and the end 99 of the hub 31 entering the opening of the inner portion 24. The rotary seal comprises a V-seal 98. A shaft seal 100 is also provided.

The outer portion 22 of the bracket 14 is adapted to be mechanically fixed to an axle housing. The axle housing is adapted to receive the hub 31 permitting rotation of the hub 31 about the axle housing.

Further, the inner portion 24 of the bracket 14 comprises a housing connection portion 34 (see FIG. 6) to enable fixing of the inner shell 28 to the bracket 14; this permits securing the housing 12 to the bracket 14 when the inner shell 28 and outer shell 26 are joined together.

The housing connection portion 34 of the bracket 14 comprises a central opening 36 through which the axle housing (not shown) will pass when the brake system 10 is mounted on the axis. In this manner, the axle housing extends into the space created by the housing 12 and in particular into the hub 31. A bearing assembly is sandwiched between the axle housing and the hub 31 to permit rotation of the hub 31 about the axle housing.

In a particular arrangement, the housing 12 comprises sealing means in order to isolate the interior of the housing 12 from the exterior of the housing 12; in this manner, no dust (containing frictional braking material) may reach the environment. The sealing means may comprise (1) the sealing assembly (such as O-ring 88) sandwiched between the inner and outer inner shells 26 and 28, (2) the rotary sealing assembly located between the outer inner shell 26 and the hub 31, and (3) a sealing assembly (such as a O-ring seal) may be sandwiched between the inner rim of the second opening 32 and the inner portion 24.

Furthermore, the bracket 14 is provided with a brake coupling portion for attachment of the caliper to the bracket 14 within the housing 12 to apply braking force to the rotor 20.

In a particular arrangement, no part of the housing 12 is subject to any substantive compression force and in particular no compression between the bracket 14 and the axle housing. It is for this reason that the housing 12 may be made in accordance with a particular arrangement from a lightweight material including but not limited to plastics and polymer materials 20 including polymer composites. Alternatively, the housing 12 may made of other suitable materials; for example, the housing 12 may made out of casted metal.

Referring back to FIGS. 1 and 2, the housing 12 in assembled condition defines a body formed by joining together the inner and outer shells 28 and 26. The body comprises a circular outer periphery 36 (the circular portion 36) having a particular arc section 39 from which a rectangular portion 38 extends radially outward defining the chamber 23 including the caliper.

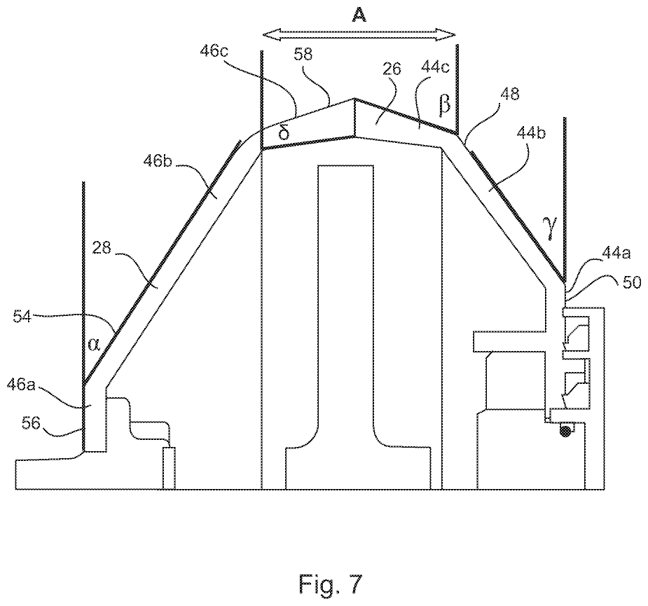

As shown in FIG. 2, each shell 26 (or 28) comprise outer peripheral section 40 (or 42) partially surrounding the opening 30 (or 32). The outer peripheral sections 40 or 42) define the circular portion 36 when the inner shells 26 and 28 are joined together. Each of the outer peripheral section 40 or 42 is defined by wall segments 44 (the first wall segments) or 46 (the second wall segments) arranged side by side (see FIG. 7).

As shown in FIG. 7, the wall segments 44 (or 46) are arranged side by side at particular orientations with respect to each other such that each wall segments 44b (the second wall segment) and 44c (the third wall segment) (or 46b [the second wall segment] and 46c [the third wall segment]) define an angle different than zero with respect to the wall segment 44a (the first wall segment). As shown in FIG. 1, an apex 37 located diametrically opposite to the chamber 23 is defined by the particular orientation of the wall segments 44 and 46.

In particular, for the outer shell 26:
a. the wall segment 44b is oriented with respect to the wall segment 44a in such a manner that the outer surface 48 of the wall segment 44b is oriented a particular angle γ with respect to the outer surface 50 of the wall segment 44a; and
b. the wall segment 44c is oriented with respect to the wall segment 44a in such a manner that the outer surface 52 of the wall segment 44c is oriented a particular angle β with respect to the outer surface 52 of the wall segment 44a.

In particular, for the inner shell 28:
a. the wall segment 46b is oriented with respect to the wall segment 46a in such a manner that the outer surface 54 of the wall segment 46b is oriented a particular angle α with respect to the outer surface 56 of the wall segment 46a; and
b. the wall segment 46c is oriented with respect to the wall segment 46a in such a manner that the outer surface 58 of the wall segment 46c is oriented the particular angle β with respect to the outer surface 56 of the wall segment 46a.

The wall segments 44c (or 46c) are configured in such a manner that their inner surface (the surface facing the space defined by the housing) are oriented a particular angle δ with respect to the wall segment 44a (or 46a).

Referring back to FIG. 1, the brake system 10 as shown in FIG. 1, is in the particular orientation as the brake system 10 would be, when mounted onto an axle 70 of a vehicle that has a fender 60 located above the brake system 10 while the brake system 10 is mounted on the axle 70 and a wheel 72 is mounted on the hub 31—see FIG. 9 The wheel 72 comprises a wheel disc 74 adapted for attachment to the hub 31, and a rim 76 for receiving a tyre 78 surrounding the rim 76.

The rim 76 surrounds the wheel disc 74 defining a space 80 behind the wheel disc 74. The space 80 is adapted to receive the housing 12.

In the particular arrangement shown in FIG. 9, the housing 12 is at least partially contained within the space 80 resulting in that the rim 76 surrounds at least partially the housing 12 defining a gap 82 between the outer circumference of the housing 12 and the inner surface 84 of the rim 76. During operation of the vehicle, the wheels rotate while the housing 12 is in the static condition resulting that the apex 37 of the housing is facing opposite (i.e. distal) to the ground 86 on which the vehicle is moving; and the chamber 23 is facing the ground 86. During rotation of the wheel 72 debris is collected by the rim 76 such that the debris moves around the housing 12 resulting in that portions of the debris fall onto the housing (in particular onto the apex 37); and other portions of the debris builds up on the inner surface 84 of the rim 76 resulting in that the gap 82 reduces its size.

The reduction in size of the gap 82 in conventional brake housings is problematic because it may reduce the gap 82 to such an extent that the outer periphery of the housing 12 enters in contact with the build-up of debris abuts. Also, in conventional brake housings the debris that falls onto the housing during rotation of the wheel builds up on the outer surface of the conventional housings resulting also in the reduction of the size of the gap 82 and potentially, the debris that has built up on the housing will make contact with the inner surface of the rim or with any debris that has built up on the inner surface of the rim 76.

In accordance with a particular arrangement of the present embodiment of the invention, the housing 12 is configured in such a manner that the surface is adapted for impeding buildup of debris on the outer surfaces of the housing 12. In particular, the peripheral sections 40 and 42 of the inner shells 26 and 28 are defined by wall segments 44 and 46 that have particular inclinations defining a particular outer periphery of the housing 12 defined when joining together inner shells 26 and 28. As will be described below, the housing 12 may be customised to be able to divert the particular material that is being thrown onto the housing during operation of the vehicle incorporating the housing 12.

In accordance with the first arrangement, the values the angles referred to above may the take any of the following values:

a. α=24° to 36°,

b. g=32° to 46°,

c. β=70°, and

d. δ=82°.

In accordance with the second arrangement, the values the angles referred to above may the take any of the following values:

a. α=15° to 48°,

b. g=15° to 48°,

c. β=65° to 88°, and

d. δ=65° to 88°

Varying the values of these angles permits customisation of housings 12 based on the particular use that will be given to the vehicle. For example, if the vehicle is a truck to be used in terrain having mainly dry sandy conditions, the angles mentioned above will differ with respect to a housing used in connection with a truck to be used in terrain having mainly crushed stone (gravel) conditions.

The reason that the angles mentioned above will vary depending on the particular conditions (dry sand or gravel) is that these two materials may or may not pile up on the outer periphery of the housing 12 depending on the particular inclination of the wall segment 44 or 46 that make up the outer periphery of the housing 12. In particular circumstances where the wall segments have a relative low inclination (thus the value of the above mentioned angles are relative low) the dry sand may slump and no build-up will be formed on the outer periphery of the housing 12; however, in contrast the gravel may not slump but buildup on the outer periphery of the housing 12. Thus, the housings 12 by varying the above mentioned angles may be customised to the particular applications of the vehicles with brake systems 10 incorporating the housings 12 in accordance with the present embodiment of the invention.

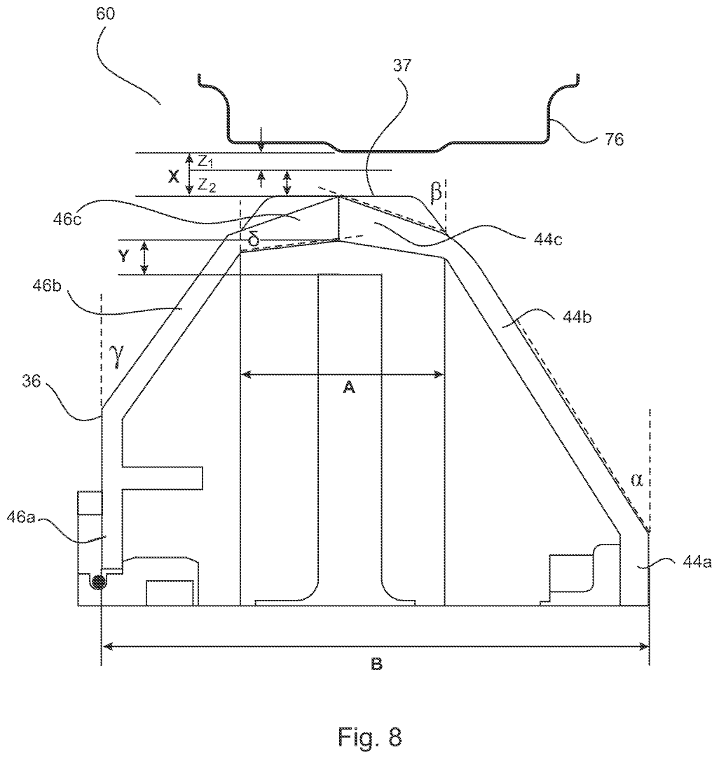

Furthermore, the housing 12 may also be customised to for use in connection with brake systems 10 to be installed in any type of vehicle such as trucks and cars as well as trailers and semi-trailers. Customisation may be done by varying particular dimensions of the housing 12. In particular, the width at particular locations of the housing may be varied. For example, the distances A and B (see FIG. 8) may be varied in order to configure the housing 12 so that it may be used connection with a multitude of different type of vehicles. The distance A corresponds to the distance defined by wall segments 44c and 46c, in particular, the separation between the point where the wall segments (1) 44a and 44b join and (2) where the wall segments 46a and 46b join. The distance B corresponds to the separation between wall segments 44a and 46a. Y is the radial clearance between the rotor 20 and the inner surface at the locations where the third wall segments 44c and 46c join.

For example, for a LandCrusier, the housing 12 would have the following values:

Distances
A=45 mm Actual+4 mm Max
B=111.48 Actual+4 mm Max
Y=5 mm Radial Clearance

Angles
α=37°
γ=47°
β=70°
δ=82°

And, for example, for a Hilux, the housing 12 could have the following values:

Distances
A=45 mm Actual+4 mm Max
B=177 Actual+4 mm Max
Y=5 mm Radial Clearance

Angles
α=24°
γ=32′
β=70°
δ=82°

Moreover, the overall diameter of the housing 32 (this is: the distance between the apex 37 and the rear surface 25 of the chamber 23) may be varied depending on the type of vehicle that will use the housing 12. In particular, the overall diameter of the housing 32 will be adjusted such that a particular spacing between the apex 37 of the housing 12 and the inner surface 84 of the rim 76 will exist when the braking system 10 is attached to the axle of the vehicle. As shown in FIG. 9, the spacing 82 may have a specific value to avoid the housing 12 (in particular its apex 37) to contact the inner surface 84 of the rim 76 and more particularly any debris that may have build-up on the inner surface of the rim 76 forming a lump of debris extending from the inner surface 84 of the rim 76 towards the housing 12—see FIG. 9.

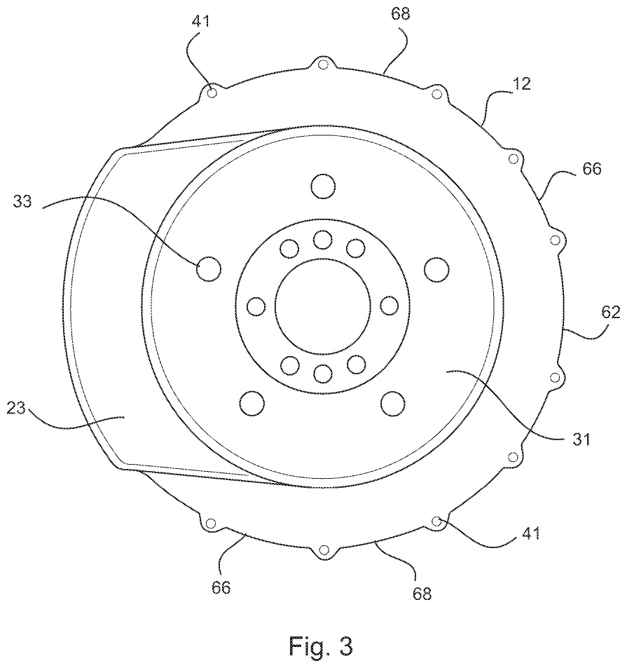

Referring now to FIGS. 3 to 5, FIGS. 3 to 5 show the housing 12 in assembled condition without containing the braking mechanism and bracket 14 attached thereto.

As shown in FIG. 3, the housing 12 comprises a plurality of protrusions 41 arranged in a spaced apart relationship with respect to each other surrounding the periphery (the circular portion 36) defined by wall segments 44c and 46c of the outer and inner shells 26 and 28 defining the housing 12.

Each protrusion 41 is defined by the sub-protrusions 43a and 43b protruding from the outer periphery of each outer and inner shells 26 and 28 that, when the outer and inner shells 26 and 28 are joined together, define each protrusion 41.

The protrusions 41 protrude outwards from the surface 62 defined by both wall segments 44c and 46c when the inner and outer shells 26 and 28 are joined together defining the housing 12. Between each adjacent protrusions 41 are formed an interspace 66 defined by a section of the wall segments 46c and 44c (see FIG. 5). The interspace 66 defines a surface 68 that is at a lower location with respect to the protrusions 41.

In this manner, a plurality of interspaces 66 (arranged in a spaced apart relationship with respect to each other) are defined surrounding the circular portion 36. As will be described with reference to the method of operation of the housing 12, each interspace 66 defines a channel permitting diverting of debris that may fall onto the periphery (the circular portion 36) defined by wall segments 44c and 46c of the outer and inner shells 26 and 28 defining the housing 12. Each channel extends transversally from one side (the outer shell) of the housing 12 to the other side (the inner shell)

During operation of the vehicle incorporating the housings 12 in their brake systems 10, the rims of the wheels of the vehicle, as they rotate while the vehicle is moving on the ground, will drive the debris to flow between the inner surfaces of the wheel disc 74 and the rim 76, and the housing 12. The thrown-up debris is contained within the spacing 82 defined by between the rim 76 and the housing 12 Typically, portions of debris may build up on the inner surface of the rim 76 and the remaining portions of debris will mainly fall onto the housing 12.

The housing 12 in accordance with the present embodiment of the invention is particularly advantageous during operation of the vehicle, in view that it is configured to impede buildup of debris on the housing 12. In particular, as mentioned before, the circular portion 36 of the housing 12 is adapted to divert any debris falling on the housing 12.

As mentioned before the circular portion 36 of the housing 12 is defined by outer peripheral section 40 and 42 comprises wall segments 44 and 46 arranged side by side at particular orientations with respect to each other. In this manner, the circular portion 36 comprises outer surfaces oriented at particular angles (such as g, b and a) defining inclined surfaces that avoid buildup of the debris onto the housing. In a particular arrangement of the present embodiment of the invention, particular housings 12 may be manufactured with inclined surfaces that have particular inclinations to avoid buildup of particular material. It has been found that by orienting the inclined surfaces at angles that coincide with the angle of repose of particular material it is possible to avoid buildup of the particular material on the inclined surface. This is particularly useful because it allows providing vehicles (such as trucks) traveling on particular material (sand or gravel) with housings 12 configured to divert the particular material on which the truck travels. During operation of the truck, any of the particular material that falls onto the housing 12 is diverted from the housing 12 and no buildup of the particular material occurs on the housing 12.

Moreover, it was mentioned before, when making reference to FIGS. 3 to 5, that the circular portion 36 of the housing comprises a plurality of interspaces 66 defined between the protrusions 41 arranged in a spaced apart relationship around the circular portion 36. And, wherein each interspace 66 defines a channel that diverts debris that may fall onto the circular portion 36 of the housing avoiding buildup of the material.

Modifications and variations as would be apparent to a skilled addressee are deemed to be within the scope of the present invention. For example, the interspaces 66 shown in, for example, FIG. 5, comprises inclined walls 44c and 46c (see FIG. 6).

In alternative arrangements, the walls 44c and 46c may not include any inclination. In this alternative arrangement:
a. the wall segment 44c is oriented with respect to the wall segment 44a in such a manner that the outer surface of the wall segment 44c is oriented a particular angle β with respect to the outer surface of the wall segment 44a, wherein the angle β is equal to 90°; and
b. the wall segment 46c is oriented with respect to the wall segment 46a in such a manner that the outer surface of the wall segment 46c is oriented a particular angle β with respect to the outer surface of the wall segment 46a, wherein the angle β is equal to 90°.

Further, it should be appreciated that the scope of the invention is not limited to the scope of the embodiments disclosed.

Throughout this specification, unless the context requires otherwise, the word “comprise” or variations such as “comprises” or “comprising”, will be understood to imply the inclusion of a stated integer or group of integers but not the exclusion of any other integer or group of integers.

1. A housing for a brake system for attachment to an axle of a vehicle, the brake system comprising a braking mechanism having a rotor attached to a hub, and a caliper for receiving a portion of the outer circumference of the rotor permitting stopping rotation of the rotor, the housing comprising a body defining the space for containment of the braking mechanism, and a circular portion having an outer periphery configured to divert debris generated during operation of the vehicle from the outer periphery, wherein the outer periphery comprises a plurality of channels arranged in a spaced apart relationship with respect to each other, the channels extending transversally from one side of the housing to the other side of the housing to divert the debris away from the outer periphery.

2. A housing according to claim 1 wherein the outer periphery comprises first and second wall segments each of the first wall segments being arranged side by side, and each of the second wall segments being arranged side by side.

3. A housing according to claim 2 wherein the first wall segments are arranged side by side at particular orientations with respect to each other such that each first wall segment define an angle different than zero with respect to the adjacent first wall segment.

4. A housing according to claim 2 or 3 wherein the second wall segments are arranged side by side at particular orientations with respect to each other such that each second wall segment define an angle different than zero with respect to the adjacent second wall segment.

5. A housing according to any one of claims 2 to 4 wherein the second wall segment of the first wall segments is oriented with respect to the first wall segment of the first wall segments in such a manner that the outer surface of the second wall segment of the first wall segments is oriented a particular angle γ with respect to the outer surface of the first wall segment of the first wall segments, wherein the angle γ can take values of either 82° or between 65° to 89° inclusive.

6. A housing according to any one of claims 2 to 5 wherein, the third wall segment of the first wall segments is oriented with respect to the second wall segment of the first wall segments in such a manner that the outer surface of the third wall segment of the first wall segments is oriented a particular angle β with respect to the outer surface of the first wall segment of the first wall segments, wherein the angle β can take values of either 70° or between 65° to 88° inclusive.

7. A housing according to any one of claims 2 to 6 wherein, the second wall segment of the second wall segments is oriented with respect to the first wall segment of the second wall segments in such a manner that the outer surface of the second wall segment of the second wall segments is oriented a particular angle α with respect to the outer surface of the first wall segment of the second wall segments, wherein the angle α can take values of either 70° or between 15° to 48° inclusive.

8. A housing according to any one of claims 2 to 7 wherein, the third wall segment of the second wall segments is oriented with respect to the second wall segment of the second wall segments in such a manner that the outer surface of the third wall segment of the second wall segments is oriented a particular angle β with respect to the outer surface of the first wall segment of the second wall segments wherein the angle β can take values of either 70° or between 65° to 88° inclusive.

9. A housing according to any one of claims 2 to 8 wherein, the third wall segment of the first wall segments are configured in such a manner that their inner surface (the surface facing towards the space of the housing) are oriented a particular angle δ with respect to the first wall segment of the first wall segments, wherein the angle δ can take values of either 82° or between 65° to 88° inclusive.

10. A housing according to any one of claims 2 to 9 wherein, the third wall segment of the second wall segments are configured in such a manner that their inner surface (the surface facing the spacing of the housing) are oriented a particular angle δ with respect to the first wall segment of the second wall segments wherein the angle δ can take values of either 82° or between 65° to 88° inclusive.

11. A housing according to any one of claims 3 to 10 wherein the angle is equal to the angle of repose of the material on which the vehicle is operating.

12. A housing according to any one of claims 2 to 11 wherein interspaces defined between the channels comprise inclined faces.

13. A housing according to any one of claims 2 to 12 wherein the third wall segment of the first wall segments is oriented with respect to the second wall segment of the first wall segments in such a manner that the outer surface of the third wall segment of the first wall segments is oriented a particular angle β with respect to the outer surface of the first wall segment of the first wall segments, wherein the angle β is equal to 90°.

14. A housing according to any one of claims 2 to 13 wherein the third wall segment of the second wall segments is oriented with respect to the first wall segment of the second wall segments in such a manner that the outer surface of the third wall segment of the second wall segments is oriented a particular angle β with respect to the outer surface of the first wall segment of the second wall segments, wherein the angle β is equal to 90°.

15. A housing according to any one of claims 2 to 14 wherein the housing comprises an outer shell facing away from the vehicle, and an inner shell facing towards the vehicle.

16. A housing according to claim 15 wherein the inner and outer shells are adapted to be releasably attached to each other for defining the space that contains the braking mechanism.

17. A housing according to any one of claim 15 or 16 wherein the inner and outer shell comprises sub-protrusions protruding from the outer periphery of each outer and inner shells and defining protrusions that define the channels therebetween, when the inner and outer shells are joined together.

18. A housing according to any one of claims 15 to 17 wherein a sealing assembly is located between the inner and outer shells.

19. A housing according to claim 18 wherein the sealing assembly comprises an O-ring gasket.

20. A housing according to any one of claims 15 to 19 wherein the outer shell comprise outer peripheral section defined by the first wall segments arranged side by side.

21. A housing according to any one of claims 15 to 20 wherein the inner shell comprise outer peripheral section defined by the second wall segments arranged side by side.

22. A brake system for attachment to an axle of a vehicle, the brake system comprising a braking mechanism having a rotor attached to a hub, and a caliper for receiving a portion of the outer circumference of the rotor permitting stopping rotation of the rotor, and a housing as defined in any one of claims 1 to 21 for containment of the braking mechanism.

23. A housing for a brake system for attachment to an axle of a vehicle, the brake system comprising a braking mechanism having a rotor rotatably attached to a hub, and a caliper for receiving a portion of the outer circumference of the rotor permitting stopping rotation of the rotor, the housing comprising inner and outer shells when joined together define a space for containment of the braking mechanism, the body being adapted to isolate the space from the exterior of the housing, wherein the housing comprises sealing means comprising a rotary-sealing assembly located between outer shell and the hub, the rotary-sealing assembly comprising a shaft seal and V-seals

24. A housing according to claim 23 wherein the inner shell comprises an opening, a seal groove surrounding the inner surface of the inner periphery of the opening and comprising the shaft seal.

25. A housing according to claim 24 wherein the inner shell further comprises a cover for mounting on the outer surface of the inner shell, the cover having an opening defining inner periphery surrounding a portion of the hub and an outer periphery comprising a plurality of concentric seal grooves facing the outer surface of the inner shell, each concentric seal grooves comprising a V-seal.

26. A housing according to claim 25 wherein the concentric seal grooves comprising the V-seals and the seal groove comprising the shaft seal are located side by side when the cover is mounted onto housing.
